(19) United States
(12) Patent Application Publication
(10) Pub. No.: US 2003/0194673 A1
(43) Pub. Date: Oct. 16, 2003

(54) Batch furnace isolation gate

(76) Inventors: Woo Sik Yoo, Palo Alto, CA (US); Yasuhide Hiraga, Kanagawa-ken (JP)

Correspondence Address: Skjerven Morrill MacPherson LLP, Suite 300, 610 Newport Center Drive, Newport Beach, CA, 92660, US

(21) Appl. No.: 10/123,378

(22) Filed: Apr. 15, 2002

(51) Int. Cl. F27D 1/18

(52) U.S. Cl. 432/250; 432/239; 432/242

(57) ABSTRACT

A processing system is provided including a process chamber defining a process chamber opening, and an apparatus for isolating the process chamber. The apparatus includes a gate member, which defines a first opening, mounted to the process chamber such that the first opening and the process chamber opening are substantially concentric. The apparatus also includes a door having a first door portion defining a second opening. The door is configured to be moveable into a first position, where the first door portion is moved over the process chamber opening until the second opening is substantially concentric with the first opening and the process chamber. The door is also configured to be moveable into a second position, where the second door portion is moved over the first opening and the process chamber opening to provide a closure for the first opening and the process chamber opening.

### BACKGROUND

1. Field of the Invention

This invention generally relates to semiconductor manufacturing equipment and, more particularly, to an apparatus for thermal processing of semiconductor wafers.

2. Related Art

During the processing of semiconductor devices, it is highly desirable to very accurately control the thermal treatment to which the devices are exposed during processing. In some instances, batches of devices, primarily wafers, are processed in a semiconductor processing furnace, which has a carefully controlled processing environment to effect the desired processes.

Of importance to the present invention are processing furnaces, which have vertically arranged wafer arrays and processing chambers. Vertically arranged furnaces were designed to provide better control of temperature and other processing parameters. In a typical vertically arranged thermal processor, the furnace assembly includes a process tube, constructed from a quartz bell jar, vertically moveable in up and down directions within a supporting framework in conjunction with a likewise moveable furnace assembly. Additionally, the furnace assembly and process tube are moveable together between up and down positions, as well as independently of one another. Heat is supplied to the thermal processor by controlling operation of heating elements within the furnace assembly. To cool the process tube within the thermal processor, the operation of the heating elements is regulated, such that interior heat is dissipated to the exterior of the processor by convection.

It is generally desirable in vertically arranged furnaces to achieve a desired temperature environment within the process chamber so that wafers or other semiconductor devices are heated at uniform rates and to uniform temperatures. The more quickly the uniform environment is achieved the less risks of processing variations between wafers and between different batches of wafers. Unfortunately, it has been found that in some instances wafers can be subjected to heat emanating from the process tube even after the wafers have been removed from the process tube. Typically, the heat emanates from the open process tube onto the wafers stored below.

For the above reasons, what is needed is an apparatus capable of isolating the process tube of a vertically arranged processing furnace.

### SUMMARY

The present invention provides an apparatus for isolating a processing chamber of a vertically arranged semiconductor device. The present invention provides a furnace assembly, which includes a processing chamber. The processing chamber defines an internal cavity, which is configured to removably receive a wafer carrier or wafer boat, having a full compliment of semiconductor wafers.

The wafer carrier is positioned vertically within the processing chamber using an actuation mechanism. After the wafers are processed, the actuation mechanism is used to remove the wafer carrier from the process chamber. The wafer carrier is transported to a loading station/cooling chamber positioned below the process chamber, where the wafer cooling process may commence.

In one aspect of the invention, a processing system is provided including a process chamber defining a process chamber opening, and an apparatus for isolating the process chamber. The apparatus includes a gate member, which defines a first opening, mounted to the process chamber such that the first opening and the process chamber opening are substantially concentric. The apparatus also includes a door having a first door portion defining a second opening. The door is configured to be moveable into a first position, where the first door portion is moved over the process chamber opening until the second opening is substantially concentric with the first opening and the process chamber. The door is also configured to be moveable into a second position, where the second door portion is moved over the first opening and the process chamber opening to provide a closure for the first opening and the process chamber opening.

Advantageously, as the wafer carrier is placed in or removed from the processing chamber, the internal cavity is kept substantially enclosed using an isolation gate, so that the processing temperature within the internal cavity can be substantially isothermally maintained. Accordingly, the risks of processing variations occurring between wafers and between different batches of wafers is substantially reduced.

The isolation gate of the present invention provides many other advantages. For example, since during continuous processing cycles the temperature of the process chamber does not substantially vary, less energy is required to maintain the process temperatures. The life usage of the heating elements is increased, since the heating circuits are not repeatedly ramping-up to load temperatures and ramping-down to cool.

These and other features and advantages of the present invention will be more readily apparent from the detailed description of the embodiments set forth below taken in conjunction with the accompanying drawings.

### BRIEF DESCRIPTION OF THE DRAWINGS

FIG. 1A is a simplified perspective view of a furnace assembly including an isolation gate in accordance with one embodiment of the present invention;

FIGS. 1B and 1C are side and front views, respectively, of the furnace assembly of FIG. 1A;

FIG. 2 is a cross-sectional view of a furnace assembly;

FIGS. 3A and 3B are perspective views of the isolation gate of FIG. 1A; and

FIGS. 4A and 4B are perspective views of the isolation gate of FIG. 1A illustrating open and closed embodiments, respectively.

### DETAILED DESCRIPTION

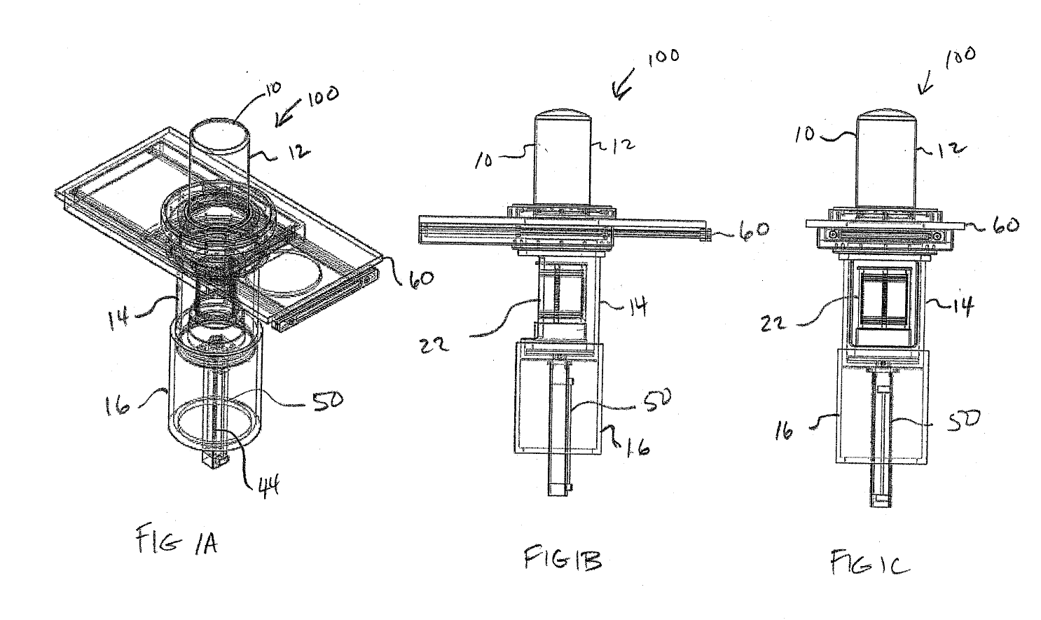

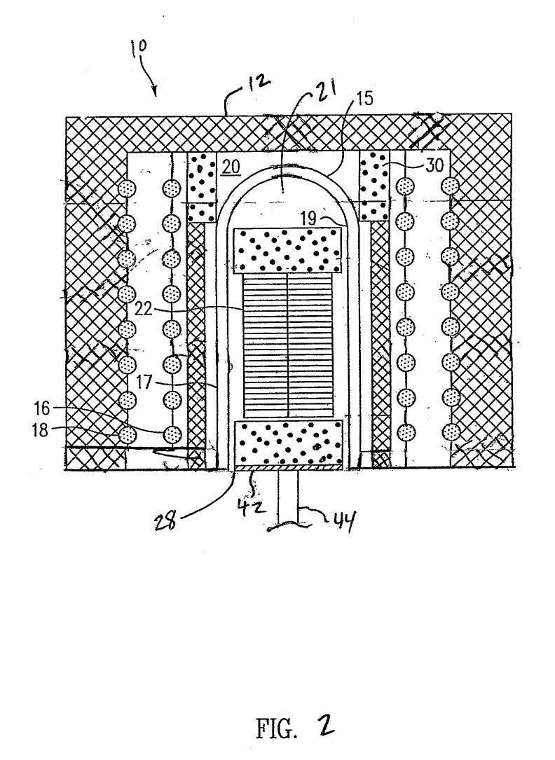

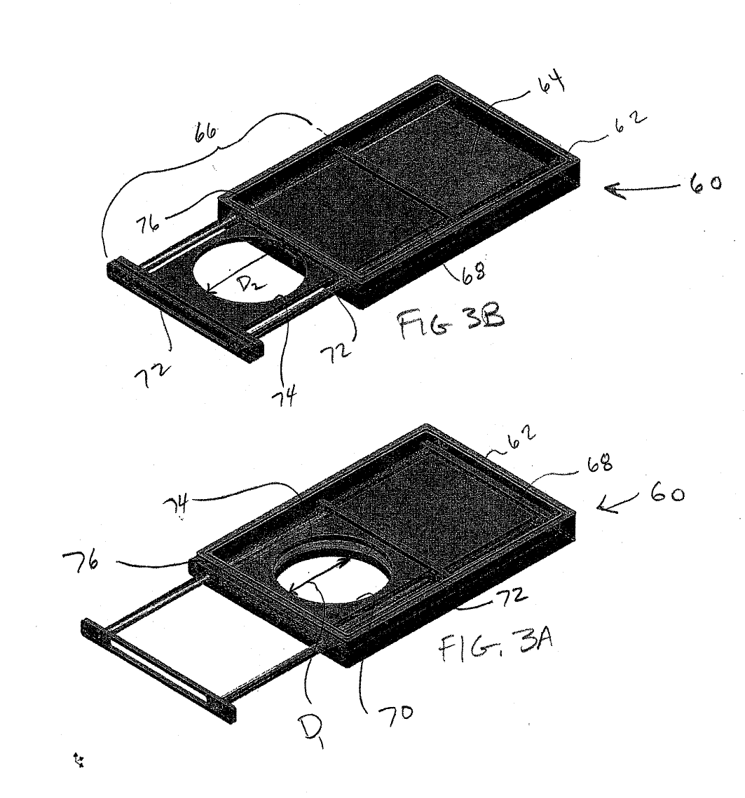

FIGS. 1A, 1B and 1C are perspective, side and front views, respectively of one embodiment of a processing system 100 in accordance with an embodiment of the present invention. In a representative embodiment shown in FIG. 2, furnace assembly 10 can include a housing 12, defining an internal space 20 enclosing a process chamber 15, a first heating circuit 16, second heating circuit 18, and other structural and insulatory components.

Referring again to FIGS. 1A-1C, furnace assembly 10 also includes a wafer cassette loading station 14 and an transfer station 16. In one embodiment of the present invention, an isolation gate 60, described below, can be mounted between process chamber 15 and loading station 14 to provide the capability of isolating process chamber 15 from an external environment.

Referring to FIG. 2, externally, housing 12 may be metallic, preferably made of aluminum, stainless steel, or similar metal. Housing 12 defines an opening 28 provided on a bottom face of housing 12. Opening 28 is sized and configured to receive a wafer carrier or wafer boat 22, including wafers for processing. Opening 28 allows for the loading and unloading of wafers to and from process chamber 15 before and after processing.

Opening 28 may be a relatively small opening, but with a width large enough to accommodate wafer carrier 22. The relatively small opening size helps to reduce radiation heat loss from process chamber 15. Also, the small aperture size keeps down the number of particles entering process chamber 15 and allows for easier maintenance of the isothermal temperature environment.

Process chamber 15 is preferably mounted within internal space 20, of housing 12. Process chamber 15, also referred to as a processing tube or jar, is preferably shaped in a form similar to a bell jar. The jar shaped chamber has a shell 15 with an outer surface 17 and an inner surface 19. Inner surface 19 defines the perimeter of the process chamber and an interior cavity 21.

Interior cavity 21, is constructed with a minimal internal volume to surround wafer carrier 22 holding a batch of wafers. Typically, process chamber 15 may withstand internal pressures of about 0.001 Torr to 1000 Torr, preferably between about 0.1 Torr and about 760 Torr. Thermal heat treatment can be done within process chamber 15 alone or with other processing steps involving exposing the semiconductor wafers to various chemicals, particularly gases, as is well-known in the art.

As illustrated in FIGS. 1A-1C and 2 a wafer carrier 22 is provided, which is capable of holding a plurality of wafers in a vertical array for processing. Wafer carrier 22 is formed of quartz or other suitable materials. Process chamber 15 and wafer carrier 22 are constructed to form a coaxial arrangement, such that wafer carrier 22 can be removably received within process chamber 15. Wafer carrier 22 has a series of wafer receivers, advantageously formed by notches, each notch being capable of holding a wafer in position during processing. Wafer carrier 22 can be designed to hold any desired number of wafers, but preferably the wafer carrier can hold between about 25 and 50 wafers. Wafer carrier 22 may be a removable cassette which is loaded into process chamber 14, either manually or with automated guided vehicles (AGV). Wafer carrier 22 may also be a fixed cassette, in which case wafers are loaded onto carrier 22 using conventional atmospheric robots or loaders.

In one embodiment, wafer carrier 22 may be configured for vertical movement using an elevator 50 to allow the wafer array to be installed and/or removed from process chamber 15.

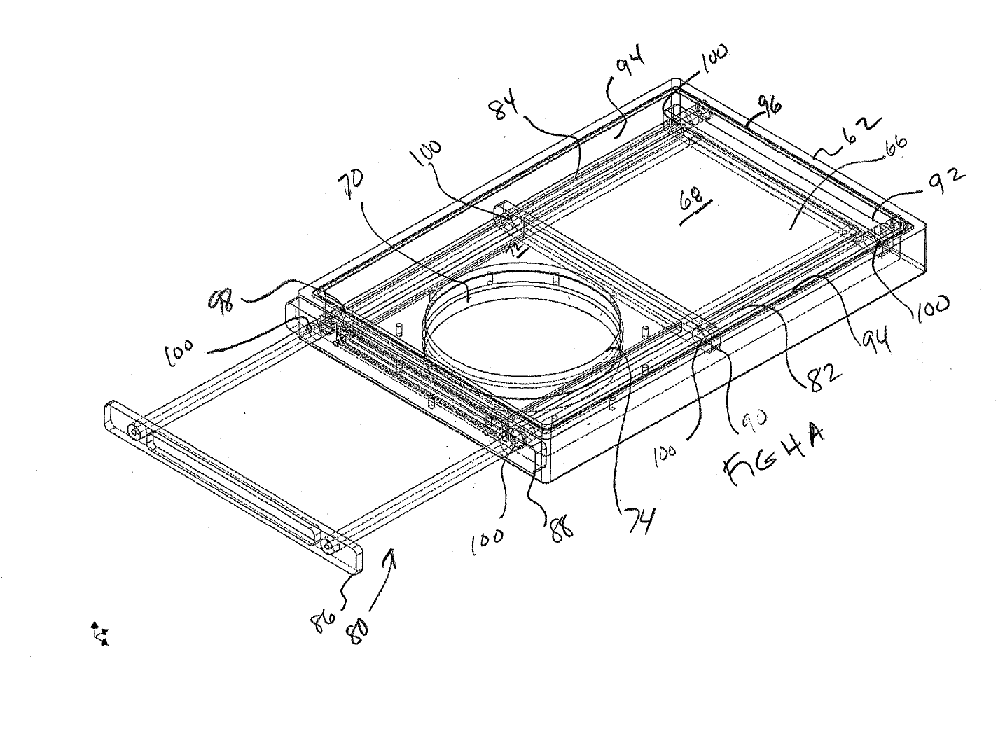

Referring now to FIGS. 1A, 3A and 3B, in accordance with one embodiment of the present invention, isolation gate 60 is positioned between housing 12 and loading station 14 positioned below process chamber 15. Isolation gate 60 includes a frame structure 62 encasing a gate member 64.

Gate member 64 is fixedly secured within frame structure 64. Gate member 64 defines a gate opening 70, which is sized and configured to be mounted over and in-line with opening 28 of housing 21. In this embodiment, opening 70 is positioned on one half of gate member 64, such that the non-opened area and the area including opening 70 are approximately equal. In one embodiment, opening 70 has a diameter D₁, which is substantially equivalent to the diameter of opening 28 (FIG. 2).

Gate member 64 includes a mounting mechanism, such as bolts, rivets and the like, which allow gate member 64 to be mounted, for example, to the bottom face of housing 21. When mounted, gate member 64 forms a seal around opening 28. The seal ensures that process gases and the like do not leak out from process chamber 15 (FIG. 2) during processing.

In one embodiment, gate member 64 is made of a material suitable for use in a wafer processing environment, such as Al and stainless steel.

In one embodiment, frame structure 62 accommodates an isolation door 66, which is slidably received into frame structure 62 through a slot 76 defined thereon. Isolation door 66 includes a first door portion 68 and a second door portion 72. In this embodiment, second door portion 72 defines a door opening 74, which is sized to have a diameter D₂ substantially equivalent to diameter D₁ of opening 70.

Isolation door 66 can be moved manually or automatically through slot 76 in a first configuration, where second door portion 72 is positioned over opening 70, such that door opening 74 is coaxial with opening 70. Isolation door 66 can also be moved manually or automatically through slot 76 into a second configuration, where first door portion 68 is made to substantially cover gate member opening 70 and housing opening 28. When in the second configuration, first door portion 68 substantially encloses process chamber 15 to isolate the chamber.

In one embodiment, first door portion 68 and second door portion 72 are configured to be slidably engaged with frame structure 62, such that door 66 slides above gate member 64. Movement of door 66 relative to gate member 64 can be accomplished using any conventional linear motion mechanism, such as those well known by those of ordinary skill in the art.

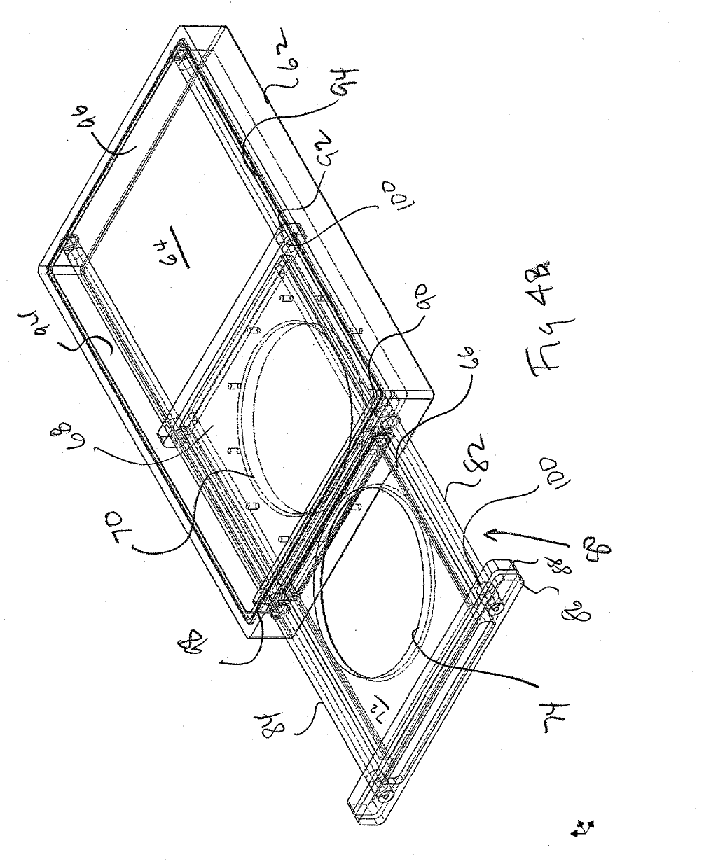

FIGS. 4A and 4B illustrate an example of the operation of isolation gate 60. In this example, isolation gate 64 includes a linear movement assembly 80. Assembly 80 can include a first rail 82, a second rail 84, and first, second, third and fourth guides 86, 88, 90 and 92. First rail 82 and second rail 84 are positioned lengthwise along the direction of travel of door 66 along each side wall 94 of frame structure 62. One end of each rail 82 and 84 is disposed outside of frame structure 62 and coupled to first guide rail 86. The other end of each rail 82 and 84 is coupled to the opposing end 96 of frame structure 62.

As shown in FIGS. 4A and 4B, door 66 is held between second guide 88 and fourth guide 92, with third guide 90 positioned half-way therebetween across the center of door 66. At each end of guide rails 88, 90 and 92 are bearings 100, such as a journal bearing or optionally ball-bearings. Bearings 100 are provided to ride along first and second rails 82 and 84 to allow door 66 to slide relative to gate member 64.

As best understood with reference to FIGS. 4A and 4B, isolation gate 60 is configured to slidably move between an open and closed position to create a substantially enclosed processing chamber before and after the removal or installation of wafer carrier 22. In operation, door 66 (FIG. 4A) is moved through slot 76 (FIG. 3A) until second guide 88 and fourth guide 92 reach the extent of travel length on rails 82 and 84 to place door 66 in an open position. In one embodiment, when in the open position, door opening 74 is positioned coaxially with opening 70 of gate member 64 providing access to opening 28 and, thus, process chamber 15. In this position, wafer carrier 22 can be moved into, or out from, process chamber 15.

Door 66 can be moved out from frame structure 62 through slot 76 until second guide 88 reaches first guide 86 and third guide 90 reaches wall 98 of frame structure 62. In this position, for example, when carrier 22 is deployed upwardly and positioned within process chamber 15, first door portion 68 covers chamber opening 28 and seals against the bottom perimeter of the chamber to form a substantially enclosed process chamber 15. Conversely, when carrier 22 is deployed downwardly from chamber 15, first door portion 68 can be moved into position to seal against the bottom perimeter of the chamber to prevent heat from leaking out of process chamber 15. In one embodiment, the seal created by first door portion 68 can be an airtight seal.

The environmental temperature achieved during processing can be substantially maintained in chamber 15 to reduce the need to substantially re-heat process chamber 15 during subsequent processing operations. Door 66 may be made of a highly insulatory material, such as opaque quartz, fibered ceramic material or other types of ceramic fibers, which are matted together to form a relatively less dense layer having good thermal insulation properties.

Referring again to FIGS. 1A-1C, furnace assembly 10 can be operated in a thermal processing system 100 in the following manner.

Loading station 14 receives wafer carrier 22. Wafer carrier 22 may be manually loaded/unloaded within loading station 14 or else may be automatically loaded/unloaded. Once wafer carrier 22 is inside loading station 14, isolation gate 60 is moved to the open position, such that chamber opening 28, ate member opening 70 and door opening 74 are concentrically aligned. A skirt (not shown) can be slid down over the opening of loading station 14 to create a load lock. Loading station 14 and process chamber 15 are maintained at atmospheric pressure or else are pumped down to vacuum pressure using a pump (not shown).

Lift assembly 50 includes a lift actuator, coupled at one end to a support plate 42 (FIG. 2) upon which wafer carrier 22 is positioned. The lift actuator, includes an extendible and retractable lift actuation rod 44, which is used to move wafer carrier 22 through door opening 74, gate member opening 70 and chamber opening 28 to position wafer carrier 22 into chamber 15. Support plate 42 is designed to be substantially the same diameter as openings 74, 70 and 28. Thus, when wafer carrier 22 is placed into chamber 15, support plate 42 provides a closure to the chamber 15 allowing wafer processing to commence. The lift actuator can be any conventional type of actuator, such as a pneumatically powered ram drive. Alternative actuators, include electrically powered, and mechanical screw type actuators.

After the wafers in wafer carrier 22 are processed in process chamber 15, lift assembly 50 retracts to lower wafer carrier 22 back into loading station 14, which provides, in effect, a cooling chamber for the newly processed wafers, which may have temperatures upwards of 100° C.

Once wafer carrier 22, including the newly processed wafers, is in loading station 14, isolation gate 60 is moved into the closed position. In this position, first door portion 68 provides closure to process chamber 15. In this manner, the cooling wafers in loading station 14 are not subjected to any heat that may otherwise leak from process chamber 15.

Having thus described the preferred embodiments, persons skilled in the art will recognize that changes may be made in form and detail without departing from the spirit and scope of the invention. Thus the invention is limited only by the following claims.

What is claimed is:

1. A processing system for heating a plurality of substrates, the system comprising:
a process chamber defining an internal space including a first opening configured to receive said plurality of substrates therethrough;
an isolation gate including a door, said door being moveable between an open position where said internal space is in communication with an external environment and a closed position, where said internal space is isolated from said external environment.

2. The system of claim 1, further comprising a loading station, said isolation gate isolating said internal space from said loading station.

3. The system of claim 2, further comprising a lift assembly wherein said lift assembly provides support for said substrates, said lift assembly configured to move said substrates from said loading station into said process chamber when said door is in said open position.

4. The system of claim 1, wherein said process chamber comprises a vertically arranged furnace.

5. The system of claim 1, wherein said door comprises a first door portion and a second door portion, said second door portion defining a second opening, said second opening being concentric with said first opening when said door is in said open position.

6. The system of claim 1, wherein said door comprises a first door portion and a second door portion, said first door portion providing closure to said first opening when said door is in said closed position.

7. The system of claim 1, wherein said door comprises an insulative material.

8. The system of claim 1, wherein said isolation gate comprises
a gate member defining a third opening, said third opening substantially concentric with said first opening; and
a door defining a second opening substantially concentric with said first opening and said third opening when in said open position.

9. The system of claim 8, wherein said door is slidable relative to said gate member from said open position to said closed position.

10. A processing system comprising:
a process chamber; and
an apparatus mounted on said processing system for isolating said process chamber, the apparatus including:
a gate member defining a second opening, said second opening substantially concentric with a first opening on said process chamber; and
a door defining a third opening, said door configured to be slidable from a first position where said third opening is substantially concentric with said first opening and said second opening and a second position where said door provides a closure to said first and second openings.

11. The system of claim 10, wherein said processing system further comprises a first heating circuit positioned proximate to said process chamber; and a second heating circuit positioned proximate to said first heating circuit, wherein a thermal energy output from said first heating circuit and said second heating circuit provide a substantially isothermal environment throughout said process chamber.

12. The system of claim 10, further comprising a loading station, said apparatus isolating said process chamber from said loading station.

13. The system of claim 12, further comprising a lift assembly wherein said lift assembly provides support for substrates, said lift assembly configured to move said substrates from said loading station into said process chamber when said door is in said first position.

14. The system of claim 10, wherein said process chamber comprises a vertically arranged furnace.

15. The system of claim 10, wherein said door comprises a first door portion and a second door portion, said second door portion defining said third opening.

16. The system of claim 10, wherein said door comprises a first door portion and a second door portion, said first door portion providing said closure to said third opening when said door is in said second position.

17. The system of claim 10, wherein said door comprises an insulative material.

18. The system of claim 10, wherein said gate member and said door are enclosed within a frame structure including rails for allowing said door to move relative to said gate member.

19. A method for heating a plurality of substrates, the method comprising:
moving a door of an isolation gate to a first position to provide access to a process chamber for a plurality of substrates;
moving said substrates into said process chamber for processing and out from said process chamber upon completion of said processing; and
moving said door of said isolation gate to a second position to provide closure to said process chamber.

20. A processing system comprising:
a process chamber defining a process chamber opening; and
an apparatus for isolating said process chamber, the apparatus including:
a gate member enclosed in a frame structure, said gate member defining a first opening on a portion of said gate member, said gate member mounted to said process chamber such that said first opening and said process chamber opening are substantially concentric; and
a door including a first door portion defining a second opening and a second door portion absent an opening, said door configured to be moveable from a first position, where said first door portion is moved over said process chamber opening until said second opening is substantially concentric with said first opening and said process chamber opening to provide access to said process chamber, to a second position, where said second door portion is moved over said first opening and said process chamber opening to provide a closure for said first opening and said process chamber opening.
